(19) United States
(12) Patent Application Publication
(10) Pub. No.: US 2013/0238707 A1
(43) Pub. Date: Sep. 12, 2013

(54) INFORMATION PROCESSING SYSTEM, INFORMATION PROCESSING METHOD, AND STORAGE MEDIUM

(71) Applicants: Shinsuke Yoshigaki, Fukuoka (JP); Akira Shimazu, Fukuoka (JP); Yoshiro Yamagami, Fukuoka (JP)

(72) Inventors: Shinsuke Yoshigaki, Fukuoka (JP); Akira Shimazu, Fukuoka (JP); Yoshiro Yamagami, Fukuoka (JP)

(73) Assignee: NEC SOFTWARE KYUSHU, LTD., Fukuoka-shi, Fukuoka (JP)

(21) Appl. No.: 13/823,863

(22) PCT Filed: Feb. 21, 2012
(86) PCT No.: PCT/JP2012/054041

§ 371 Date: May 21, 2013

(30) Foreign Application Priority Data
Mar. 31, 2011 (JP) 2011-080966

(51) Int. Cl. H04L 12/58

(52) U.S. Cl. CPC H04L 51/04
USPC 709/204

(57) ABSTRACT

To more effectively motivate a user to transmit information, an information processing system includes an information receiver that receives real-time information transmitted by a user terminal, a distributor that distributes the received real-time information to other predetermined user terminals, an analyzer that analyzes responses, from the other user terminals, to the distributed real-time information, an evaluator that evaluates the real-time information according to an analysis result, and an incentive provider that provides an incentive corresponding to the evaluation of the real-time information to a user who has transmitted the real-time information.

### TECHNICAL FIELD

The present invention relates to a communication technique using social media.

### BACKGROUND ART

In the above-described technical field, there is known a technique of evaluating contents tweeted by a user using so-called Twitter®, as described in patent literature 1.

### CITATION LIST

### Patent Literature

Patent literature 1: Japanese Patent Laid-Open No. 2009-193133

### SUMMARY OF THE INVENTION

### Technical Problem

Since, however, the above-described conventional technique cannot provide an incentive for contents distributed by the user, he/she does not have strong enough motivation to transmit information.

The present invention enables to provide a technique of solving the above-described problem.

### Solution to Problem

One aspect of the present invention provides a system comprising:

an information receiver that receives real-time information transmitted by a user terminal;

a distributor that distributes the real-time information received by the information receiver to other predetermined user terminals;

an analyzer that analyzes responses, from the other user terminals, to the real-time information distributed by the distributor;

an evaluator that evaluates the real-time information according to an analysis result by the analyzer; and

an incentive provider that provides an incentive corresponding to the evaluation of the real-time information by the evaluator to a user who has transmitted the real-time information.

Another aspect of the present invention provides a method comprising:

receiving real-time information transmitted by a user terminal;

distributing the real-time information received in the receiving to other predetermined user terminals;

analyzing responses, from the other user terminals, to the real-time information distributed in the distributing;

evaluating the real-time information according to an analysis result in the analyzing; and

providing an incentive corresponding to the evaluation of the real-time information in the evaluating to a user who has transmitted the real-time information.

Still another aspect of the present invention provides a storage medium storing a program for causing a computer to execute:

receiving real-time information transmitted by a user terminal;

distributing the real-time information received in the receiving to other predetermined user terminals;

analyzing responses, from the other user terminals, to the real-time information distributed in the distributing;

evaluating the real-time information according to an analysis result in the analyzing; and

providing an incentive corresponding to the evaluation of the real-time information in the evaluating to a user who has transmitted the real-time information.

### ADVANTAGEOUS EFFECTS OF INVENTION

According to the present invention, it is possible to more effectively motivate the user to transmit information.

### BRIEF DESCRIPTION OF DRAWINGS

FIG. 1 is a block diagram showing the configuration of an information processing system according to the first embodiment of the present invention;

FIG. 2 is a block diagram showing the configuration of an information processing system according to the second embodiment of the present invention;

FIG. 3 is a sequence chart showing a processing procedure in the information processing system according to the second embodiment of the present invention;

FIG. 4 is a block diagram showing the arrangement of an information processing apparatus according to the second embodiment of the present invention;

FIG. 5 is a table showing user information in the information processing system according to the second embodiment of the present invention;

FIG. 6 is a table showing tweet evaluation information in the information processing system according to the second embodiment of the present invention;

FIG. 7 is a flowchart illustrating processing by a user terminal in the information processing system according to the second embodiment of the present invention;

FIG. 8 is a view showing an example of the display screen of the user terminal in the information processing system according to the second embodiment of the present invention;

FIG. 9 is a view showing an example of the display screen of the user terminal in the information processing system according to the second embodiment of the present invention;

FIG. 10 is a view showing an example of the display screen of the user terminal in the information processing system according to the second embodiment of the present invention;

FIG. 11 is a view showing an example of the display screen of the user terminal in the information processing system according to the second embodiment of the present invention;

FIG. 12 is a view showing an example of the display screen of the user terminal in the information processing system according to the second embodiment of the present invention; and

FIG. 13 is a block diagram showing the configuration of an information processing system according to the third embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

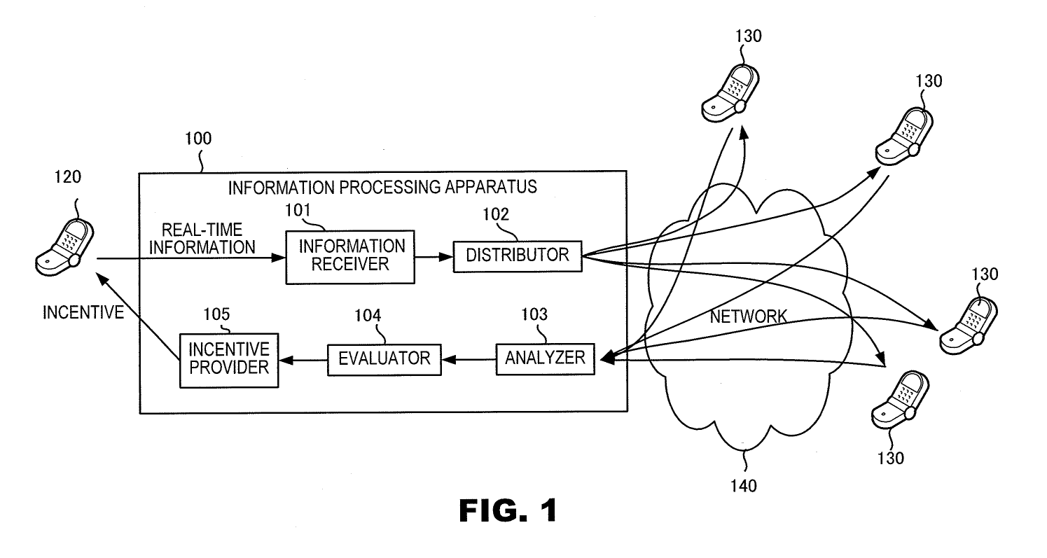

An information processing system according to the first embodiment of the present invention will be described with reference to FIG. 1. As shown in FIG. 1, the information processing system includes an information processing apparatus 100, and user terminals 120 and 130 connected to the information processing apparatus 100 via a network 140. The information processing apparatus 100 includes an information receiver 101, a distributor 102, an analyzer 103, and an evaluator 104.

The information receiver 101 receives real-time information from the user terminal 120. The distributor 102 distributes the real-time information received by the information receiver 101 to the other predetermined user terminals 130. The analyzer 103 analyzes responses, from the other user terminals 130, to the real-time information distributed by the distributor 102. The evaluator 104 evaluates the real-time information according to an analysis result by the analyzer 103. According to the evaluation of the real-time information by the evaluator 104, an incentive provider 105 provides an incentive to the user terminal 120 which has transmitted the real-time information.

The above-described configuration enables to effectively motivate the user to transmit information.

### Second Embodiment

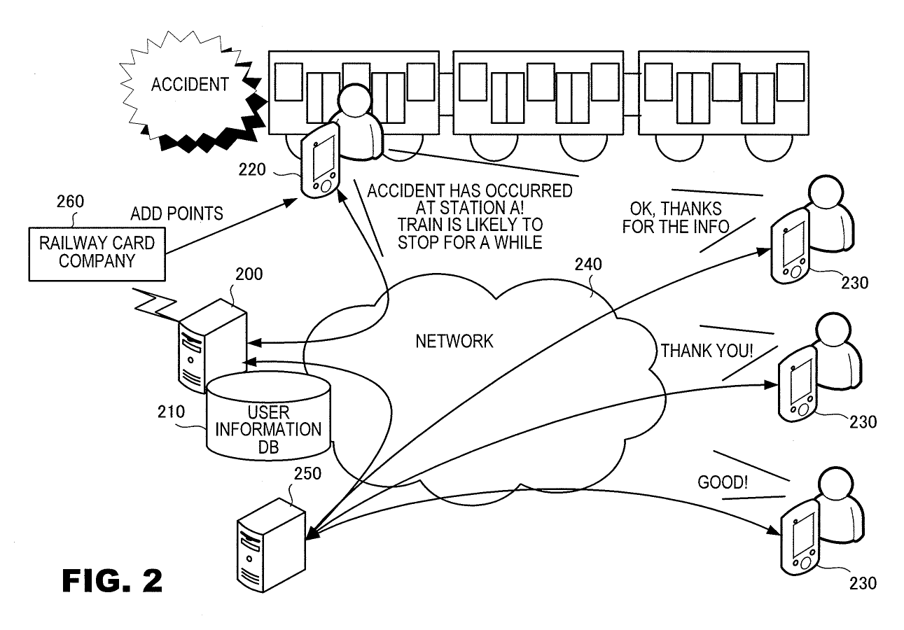

An information processing system according to the second embodiment of the present invention will now be described with reference to FIGS. 2 to 12.

<System Configuration>

FIG. 2 is a block diagram for explaining the overall configuration of the information processing system according to the embodiment. Assume that in FIG. 2, the user is on a train and the train has stopped because of an accident. In this case, the user activates a disaster information submission application in a user terminal 220 such as a mobile phone or smartphone, and submits a short message like “Accident has occurred at station A! Train is likely to stop for a while”. In this example, assume that the user uses the service of Twitter® (to be referred to as TW hereinafter). The disaster information submission application installed in the user terminal 220 accesses a disaster information submission server 200 to transmit the message which has been input by the user. Based on the message received from the user terminal 220, the disaster information submission server 200 instructs a TW server 250 to distribute a tweet. The TW server 250 receives the tweet from the user terminal 220 via the disaster information submission server 200, and then distributes it to user terminals 230 of other users registered in advance as followers.

The other users can use their user terminals 230 to send replies (RT) (retweets) to the tweet from the user terminal 220. The collected retweets are sent to the disaster information submission server 200 via the TW server 250, and analyzed and summarized. Points corresponding to the contents and the number of the retweets are added to a train card such as Suica®, and given as an incentive to the user of the user terminal 220.

This configuration motivates the user to distribute useful information when he/she gets involved in an accident.

<Overall Processing Procedure>

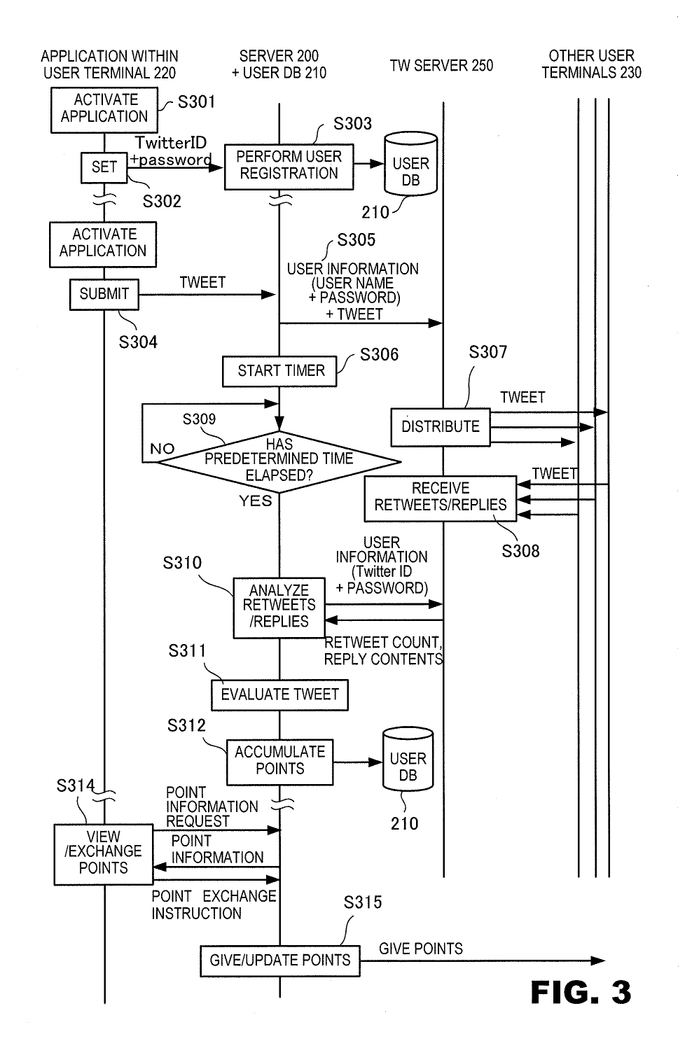

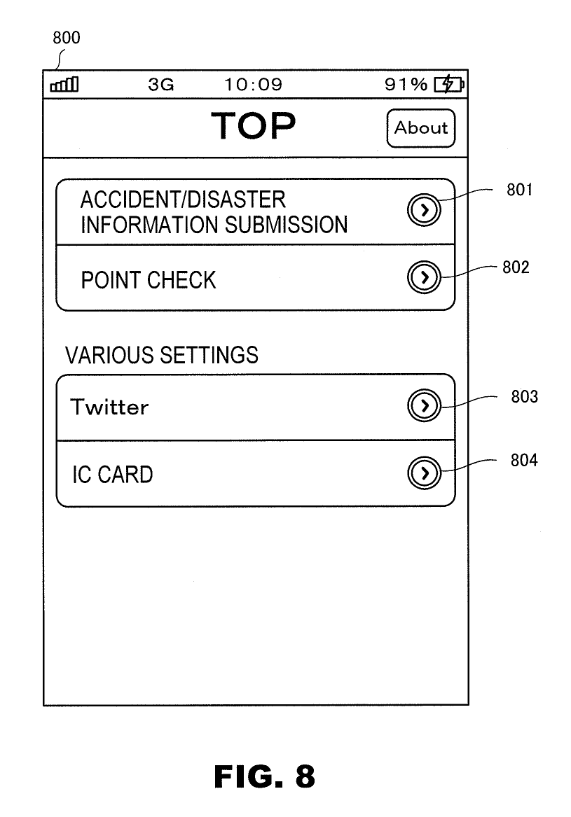

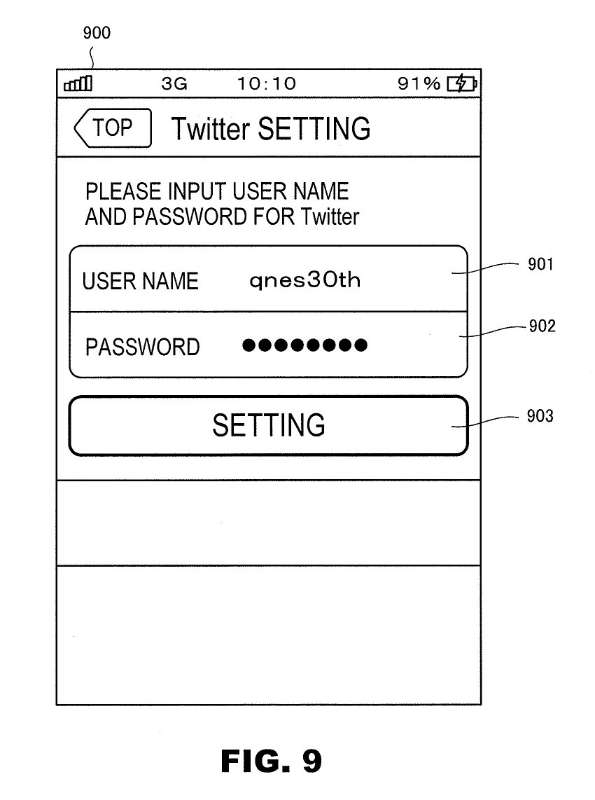

FIG. 3 is a sequence chart for explaining the overall processing procedure of the information processing system shown in FIG. 2. Referring to FIG. 3, the user terminal 220 activates the disaster information submission application in response to a user operation (S301). FIG. 8 is a view showing an example of a top screen 800 of the disaster information submission application. If a Twitter® button 803 in a field of various settings is selected on the top screen, the process advances to step S302 of FIG. 3 to display a screen 900 shown in FIG. 9. In the screen 900, the user inputs, to the user terminal 220, a user name (Twitter ID) and a password for using the service of Twitter®. If a setting button 903 on the screen 900 is selected, the user name and password are sent to the disaster information submission server 200, and registered in a user information database 210 (S303). The user registration processing in S301 to S303 need only be executed once when the disaster information submission application is downloaded and installed in the user terminal 220.

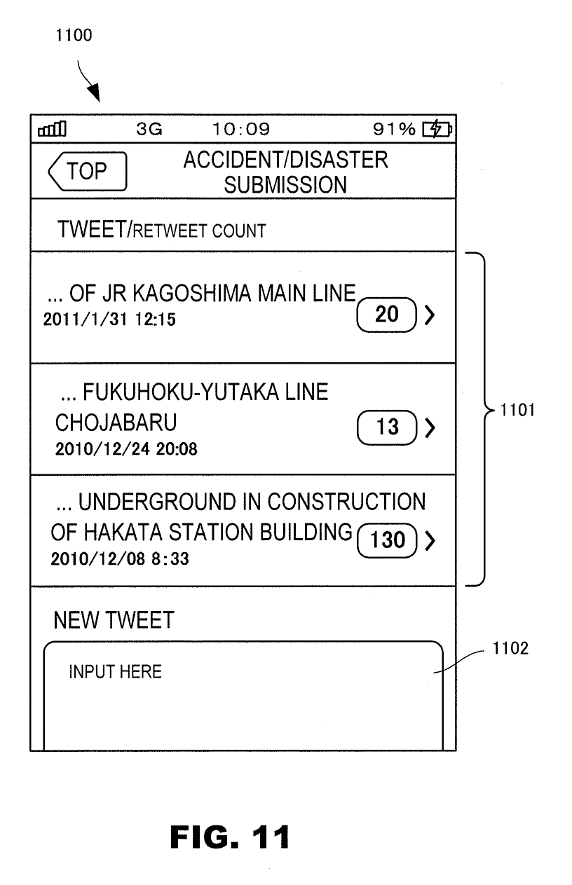

If the user encounters a disaster and wants to submit disaster information, he/she activates the application, similarly to the processing in S301 described above. If the user selects an accident/disaster information submission button 801 on the top screen 800 shown in FIG. 8, the application displays an accident/disaster information submission screen 1100 shown in FIG. 11, and transmits a new tweet message input in an input field 1102 to the disaster information submission server 200 (S304). Upon accepting the tweet, the disaster information submission server 200 transfers, to the TW server 250, the user information (user name and password) stored in association with the terminal ID of the user terminal 220, and the tweet received from the user terminal 220 (S305), and starts a timer (S306). The TW server 250 distributes the tweet received from the disaster information submission server 200 to the followers associated with the user name of the user terminal 220 (S307). More specifically, the TW server 250 temporarily stores the tweet in a storage area (time line) assigned to each user in a database it manages.

If the other users operating the other user terminals 230 send tweets (replies or retweets) associated with the tweet distributed in step S307, the TW server 250 receives the associated tweets, and accumulates them in a storage area (not shown) for the user of the user terminal 220 (S308). Note that a retweet indicates transmission (transfer) of a tweet from a user's own account by quoting a tweet of another user.

If a predetermined time elapses after step S306 (S309), the disaster information submission server 200 requests a retweet count and reply contents of the TW server 250, and analyzes the acquired contents (S310). In step S311, the server 200 uses an analysis result to evaluate the original tweet. That is, as the retweet count is larger, the tweet is more highly evaluated. Furthermore, positive replies are extracted. As the number of positive replies is larger, the tweet is more highly evaluated. Based on the evaluation of the tweet, points are accumulated in the user DB (S312). Whether contents of a reply are positive is determined depending on whether predetermined positive words such as “thank you” and “good” are included in the text of the reply.

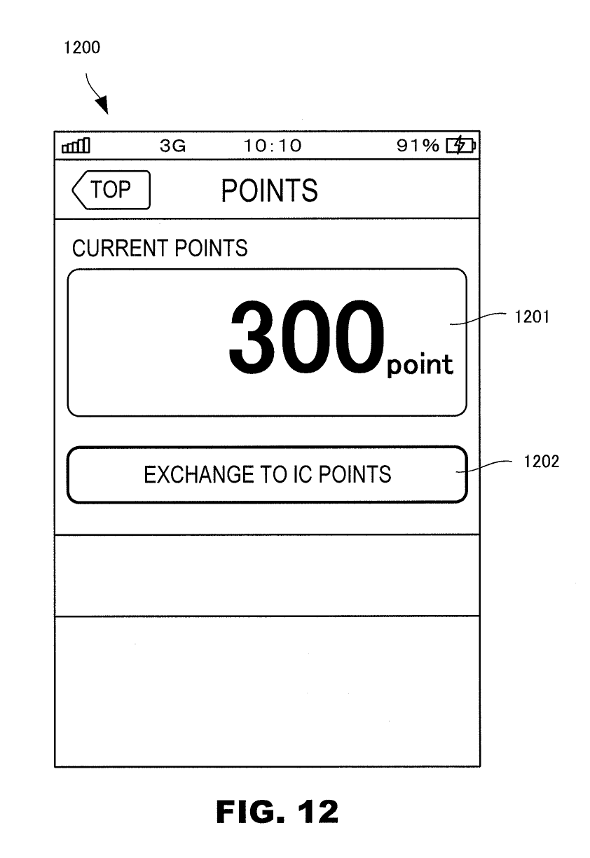

On the other hand, if the user activates the disaster information submission application, and selects a point check button 802 in FIG. 8, a point check screen 1200 shown in FIG. 12 is displayed (S314). In this example, the application requests and acquires point information from the disaster information submission server 200, and displays it in a point field 1201 of the point check screen 1200 of the user terminal 220. If the user selects an IC point exchange button 1202 of the point check screen 1200, a point exchange instruction is transmitted to the disaster information submission server 200, and all the points accumulated in the user information database 210 or only some points designated by the user are added as points of a card designated by the user via a card company (step S315).

<Arrangement of Disaster Information Submission Server>

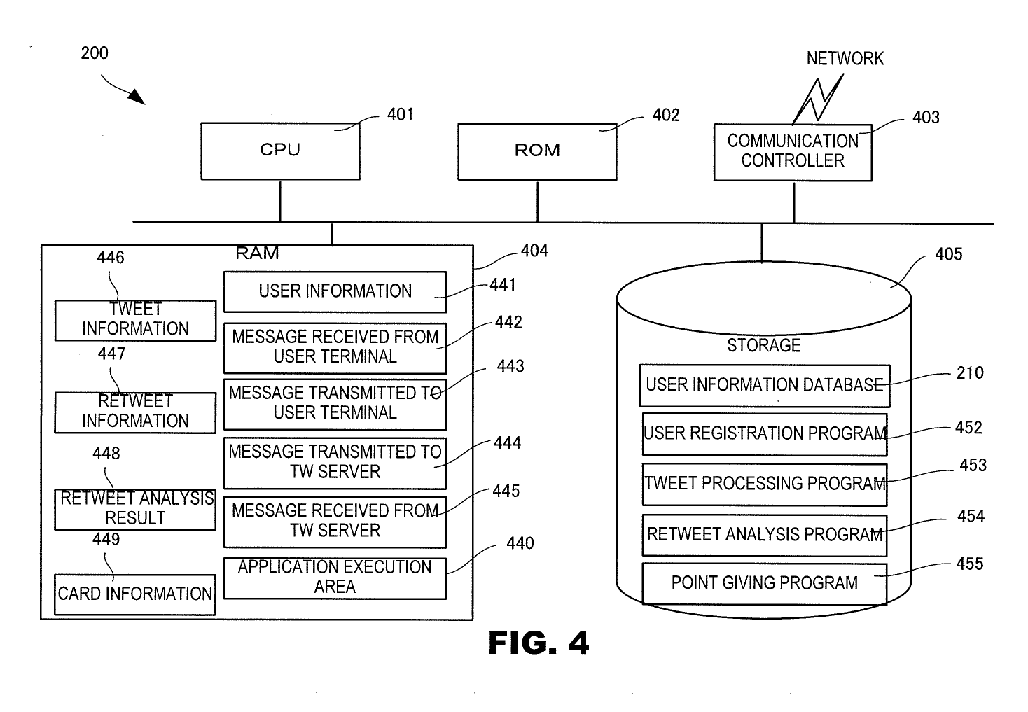

FIG. 4 is a block diagram showing the hardware arrangement of the disaster information submission server 200. As shown in FIG. 4, the disaster information submission server 200 includes a CPU (Central Processing Unit) 401 , a ROM (Read Only Memory) 402, a communication controller 403, a RAM (Random Access Memory) 404, and a storage 405. The CPU 401 is a central processing unit, and controls the disaster information submission server 200 as a whole by executing various programs. The ROM 402 is a non-volatile memory, and stores various parameters and the like in addition to a boot program to be executed first by the CPU 401.

The RAM 404 is a random access memory, and includes an application execution area 440, and a storage area for data used by the application. More specifically, the RAM 404 can temporarily store user information 441 received from the user terminal 220, a message 442 received from the user terminal 220 including a command for tweet submission or the like, and a message 443 transmitted to the user terminal 220 including tweet contents and the number of points. Furthermore, the RAM 404 includes an area for temporarily storing a message 444 transmitted to the TW server 250 such as a tweet, and a message 445 received from the TW server 250 such as a retweet count and a reply. The RAM 404 also includes an area for temporarily storing tweet information 446, retweet information 447, a retweet analysis result 448, and card information 449.

On the other hand, the storage 405 stores a user registration program 452, a tweet processing program 453, a retweet analysis program 454, and a point giving program 455 in addition to the user information database 210. The communication controller 403 controls communication with another terminal via the network. The user registration program 452 is a program for executing the processing in step S303 of FIG. 3. The tweet processing program 453 is a program for executing the processing in step S305 of FIG. 3. The retweet analysis program 454 is a program for executing the processing in step S310 of FIG. 3. The point giving program 455 is a program for executing the processing in step S315 of FIG. 3.

<Structure of User Information Database>

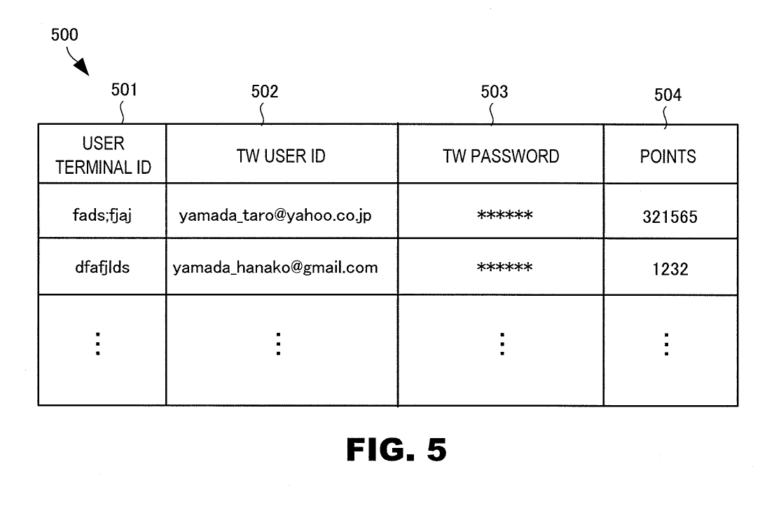

FIG. 5 shows a table 500 showing the structure of the user information database 210. In the table 500, a user terminal ID 501, a user name (TW user ID) 502 and password (TW password) 503 for logging in to the Twitter server are stored in association with each other. Furthermore, points 504 for each user terminal are summed and managed.

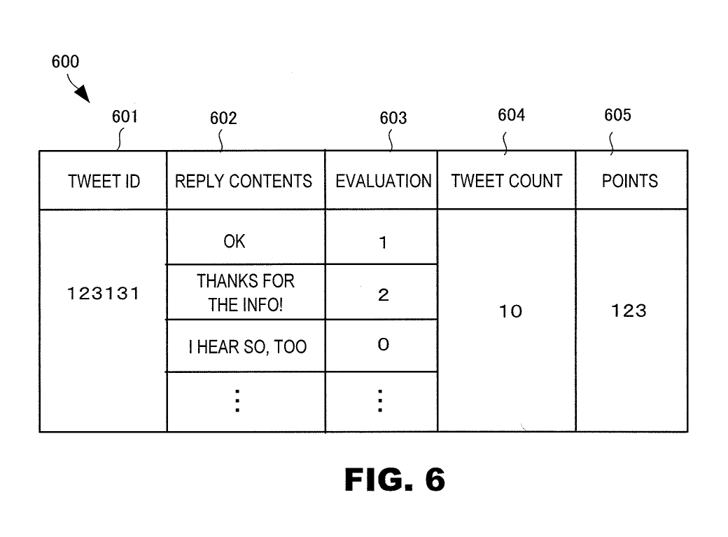

FIG. 6 shows a tweet table 600 partially forming the user information database 210. As shown in FIG. 6, contents 602 of a reply returned in response to one tweet specified by a tweet ID 601 are registered and analyzed, thereby determining evaluation points 603. Furthermore, a retweet count 604 indicating the number of times the tweet specified by the tweet ID 601 is retweeted is also acquired from the TW server 250, and registered in the tweet table 600. Points 605 to be added by the specified tweet are calculated by summarizing evaluations for the respective replies and the retweet count. The points 605 are subsequently added to the points 504 of the table 500.

<Processing Procedure in User Terminal>

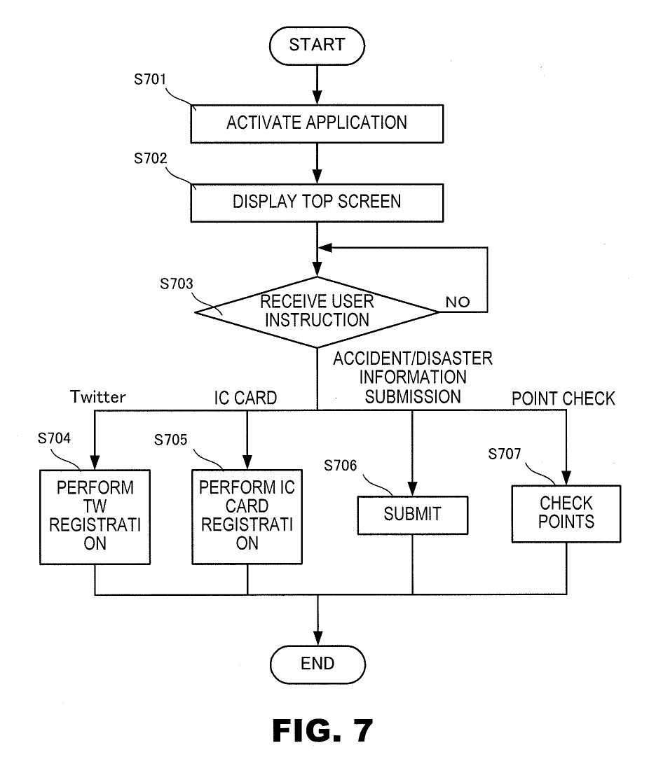

FIG. 7 is a flowchart illustrating a processing procedure executed by activating the disaster information submission application in the user terminal 220. If the disaster information submission application is activated in step S701, the top screen 800 shown in FIG. 8 is displayed in the user terminal 220 in step S702. In step S703, the process stands by for receiving a selection instruction from the user through the top screen 800. If the user selects the button 803 shown in FIG. 8, the process advances to step S704 of FIG. 7 to display the screen 900 shown in FIG. 9. If the user inputs a user name 901 and a password 902 for Twitter, and presses the setting button 903, the input information is sent to the disaster information submission server 200.

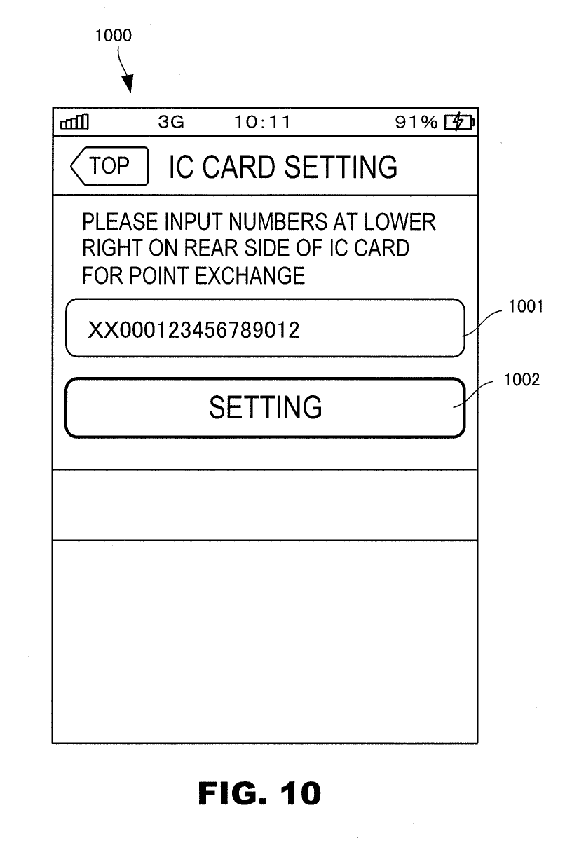

If the user selects an IC card registration button 804 shown in FIG. 8, the process advances to step S705 to cause the user terminal 220 to display an IC card setting screen 1000 shown in FIG. 10, thereby prompting the user to input information such as an IC card name or IC card number in a number input field 1001 or the like. If the user selects a setting button 1002 after that, the input information is transmitted to the disaster information submission server 200, and the disaster information submission server 200 registers the received information in the user information database 210. On the other hand, if the user selects the accident/disaster information submission button 801 shown in FIG. 8, the process advances to step 5706 to display the accident/disaster information submission screen 1100 shown in FIG. 11, thereby causing registration processing to progress.

If the user selects the point check button 802 shown in FIG. 8, the process advances to step 5707 to display the point check screen 1200 shown in FIG. 12 as described above. Point information is acquired from the disaster information submission server 200, and displayed in the point field 1201. If the user then selects the IC point exchange button 1202, a point exchange instruction is transmitted to the disaster information submission server 200, and all the points accumulated in the user information database 210 or only some points designated by the user are added as points of a card designated by the user via a card company.

As described above, according to the embodiment, it is possible to evaluate a tweet using replies and a tweet count. If the tweet is highly evaluated, the user is provided with an incentive (card points). This can increase the motivation of the user to tweet. A railway company as a card provider can distribute the current rail status in real time with the help of the user, thereby enabling to efficiently increase customer satisfaction. The railway company as the user of the application can use this as an opportunity to provide another service to the user. Meanwhile, other users can identify the current rail status in real time. The railway company can take this as an opportunity to provide associated services such as timetables and transfer information to other users.

Note that in this embodiment, a lapse of the predetermined time is used as a trigger to analyze retweets. The present invention, however, is not limited to this, and reception of a predetermined number of retweets may be used as a trigger.

### Third Embodiment

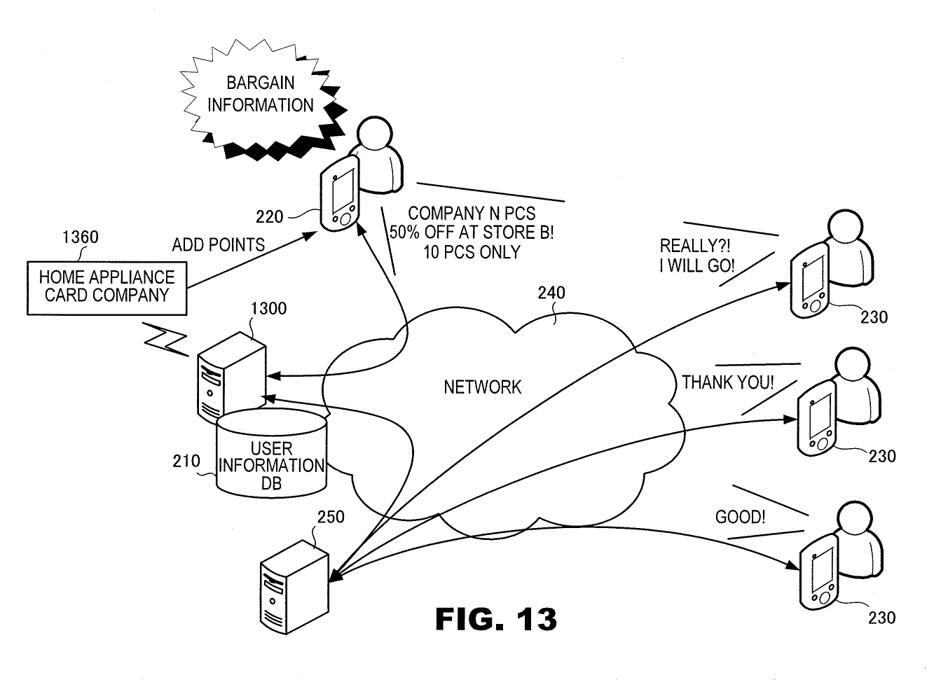

An information processing system according to the third embodiment of the present invention will now be described with reference to FIG. 13. FIG. 13 is a block diagram for explaining the configuration of the information processing system according to the embodiment. A sale information submission server 1300 according to this embodiment is different from the submission server in the above-described second embodiment in that bargain information and the like are tweeted instead of transportation information, and retweets and replies from other users are evaluated. Other components and operations are the same as those in the second embodiment. The same components and operations, therefore, have the same reference numerals, and a detailed description thereof will be omitted.

Similarly to the disaster information submission server 200 according to the second embodiment, the sale information submission server 1300 according to this embodiment relays a tweet to a TW server 250, and evaluates a retweet count and reply contents acquired from the TW server 250 to calculate points given as an incentive to the user. In this case, the points are added to the point card of the user via a home appliance card company 1360 or the like.

According to this embodiment, responses and retweets to any real-time information are used to effectively increase the motivation of the user to tweet.

### Other Embodiments

While the present invention has been described with reference to exemplary embodiments, it is to be understood that the invention is not limited to the disclosed exemplary embodiments. Various changes can be made for the arrangement and details of the present invention within the scope of the present invention, as is understood by those skilled in the art. A system or apparatus formed by combining separate features included in the respective embodiments in any form is also incorporated in the present invention.

The present invention may be applied to a system including a plurality of devices or a single apparatus. The present invention is also applicable to a case in which an information processing program for implementing the functions of the embodiments is supplied to the system or apparatus directly or from a remote site. Hence, the program installed in a computer to implement the functions of the present invention by the computer, or a medium storing the program or a WWW (World Wide Web) server to download the program is also incorporated in the present invention.

This application is based upon and claims the benefit of priority from Japanese patent application No. No. 2011-080966, filed on Mar. 31, 2011, the disclosure of which is incorporated herein in its entirety by reference

1. An information processing system comprising:
an information receiver that receives real-time information transmitted by a user terminal;
a distributor that distributes the real-time information received by said information receiver to other predetermined user terminals;
an analyzer that analyzes responses, from the other user terminals, to the real-time information distributed by said distributor;
an evaluator that evaluates the real-time information according to an analysis result by said analyzer; and
an incentive provider that provides an incentive corresponding to the evaluation of the real-time information by said evaluator to a user who has transmitted the real-time information.

2. The information processing system according to claim 1, wherein the real-time information received by said information receiver is a tweet for a Twitter® server, which has transmitted by the user terminal.

3. The information processing system according to claim 2, wherein said distributor transfers the tweet received from the user terminal to the Twitter® server.

4. The information processing system according to claim 1, wherein said analyzer analyzes the number of times the other user terminals transfer the real-time information distributed by said distributor.

5. The information processing system according to claim 4, wherein if the number of times is large, said evaluator highly evaluates the real time information.

6. The information processing system according to claim 1, wherein said analyzer analyzes replies, from the other user terminals, to the real-time information distributed by said distributor.

7. The information processing system according to claim 1, wherein
said analyzer extracts a positive reply from replies, from the other user terminals, to the real-time information distributed by said distributor, and
if the number of positive replies is large, said evaluator highly evaluates the real-time information.

8. The information processing system according to claim 1, wherein said incentive provider provides an incentive to the user by adding, to a point card of the user, points corresponding to the evaluation of the real-time information.

9. An information processing method comprising:
receiving real-time information transmitted by a user terminal;
distributing the real-time information received in the receiving to other predetermined user terminals;
analyzing responses, from the other user terminals, to the real-time information distributed in the distributing;
evaluating the real-time information according to an analysis result in the analyzing; and
providing an incentive corresponding to the evaluation of the real-time information in the evaluating to a user who has transmitted the real-time information.

10. A storage medium storing an information processing program for causing a computer to execute:
receiving real-time information transmitted by a user terminal;
distributing the real-time information received in the receiving to other predetermined user terminals;
analyzing responses, from the other user terminals, to the real-time information distributed in the distributing;
evaluating the real-time information according to an analysis result in the analyzing; and
providing an incentive corresponding to the evaluation of the real-time information in the evaluating to a user who has transmitted the real-time information.
